(19) United States
(12) Patent Application Publication
(10) Pub. No.: US 2016/0088170 A1
(43) Pub. Date: Mar. 24, 2016

(54) Systems and Methods for Configuring an Imaging Device to Image Media Using Settings Suitable for the Media

(71) Applicant: Lexmark International, Inc., Lexington, KY (US)

(72) Inventors: Calvin Dale Murphy, Georgetown, KY (US); Byrone Aguilar Victor, Lapu Lapu (PH); Gillian Jane Ross, Newark, DE (US)

(21) Appl. No.: 14/955,343

(22) Filed: Dec. 1, 2015

Related U.S. Application Data
(62) Division of application No. 14/189,385, filed on Feb. 25, 2014.

(51) Int. Cl. H04N 1/00; G06K 15/02; G06F 3/12

(52) U.S. Cl. CPC H04N 1/00334; G06F 3/1204; G06F 3/1254; G06F 3/1288; G06F 3/1292; G06K 15/021; H04N 1/00973; H04N 2201/0094

(57) ABSTRACT

A method of automatically configuring an imaging device to print on a media using one or more operating parameters suitable for the media is disclosed. The method includes receiving a barcode corresponding to the media to be printed on by the imaging device, determining one or more characteristics of the media using the barcode, retrieving one or more print settings to be used by the imaging device to print on the media having the one or more characteristics, detecting one or more environmental conditions of the imaging device, and adjusting the one or more operating parameters to print on media having the one or more characteristics based on the detected environmental conditions.

This application claims priority as a division of U.S. patent application Ser. No. 14/189, 385, having the same title, filed Feb. 25, 2014.

### FIELD OF THE INVENTION

The present invention relates to automatically configuring an imaging device to print using print settings. More particularly, it relates to systems and methods of automatically configuring an imaging device to print on a media using the print settings suited for the media.

### BACKGROUND

Typically, printing on a media by an imaging device utilizes print settings based on the type of media being used. In a printing environment, certain settings for printing are adjusted based upon the attributes of the media. When the media is loaded into an input tray of the imaging device, the user of the imaging device should enter information about the media they wish to print in order for the imaging device to determine the print settings to use to achieve the best print quality. When the user adds new media to the imaging device using a media tray, the user is expected to set or confirm the media type, media weight and media texture and other media attributes which usually requires the user to manually input the attributes may not yield accurate results since the attributes of the media may not be readily available to the user. Manually inputting the attributes may also be time-consuming for the user.

Alternatively, some imaging device systems pick the media in the input tray and advance it through the imaging device, and then determine the type and/or characteristics of the media, adjust the settings for printing thereon, and proceed with printing onto the media. However, this example imaging device system is usually less desirable as the imaging device cannot know what type of media is being picked until after advancing the media, which reduces the throughput of media in the imaging device. In some printers, the imaging occurs before the paper is picked because the distance from imaging to transfer is longer than the distance from paper pick to transfer.

Accordingly, a need exists in the art for a faster and more straightforward method of determining optimum settings for an imaging device based on attributes of the media to be used by the imaging device. What is also needed is a method of adjusting settings of an imaging device to produce consistently desirable quality output across all media types. Additional benefits and alternatives are also sought when devising solutions.

### SUMMARY

The above-mentioned and other problems are solved by systems and methods for automatically configuring an imaging device to print using one or more print settings suitable for the media and one or more detected conditions of the environment. In a representative embodiment, the method includes receiving a barcode corresponding to the media to be printed on by the imaging device. The barcode is then used to index a media translation table for retrieving the print settings suitable for use by the imaging device to print on the media. One or more conditions of the environment are detected by the imaging device, and the print settings retrieved for use by the imaging device are used to adjust operating parameters based on the detected environmental conditions. In an alternative example embodiment, a user of the imaging device is prompted to enter the barcode upon placing the media into the media tray of the imaging device receiving a new media for use in printing.

In an alternative example embodiment, another device such as, a mobile device and/or a client device, is used to retrieve the barcode of a media to be used by an imaging device, and synchronize the information to the imaging device. In this example embodiment, the device scans the barcode corresponding to the media and retrieves the print settings from the media from a server. The print settings from the server are then entered or synced with the imaging device. The imaging device, upon receiving the print settings, automatically configures the operating parameters in accordance with the print settings and the environmental conditions determined to be suitable for printing on the media.

These and other example embodiments are set forth in the description below. Their advantages and features will become readily apparent to skilled artisans. The claims set forth particular limitations.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is an example system including an imaging device, a client computer, a server and a mobile device;

FIG. 2 shows an example stack of media with a barcode relating to the media;

FIG. 3 is a flowchart showing an example method of configuring an imaging device to print on a media using one or more print settings suitable for the media;

FIG. 4 is an example method of using a device connected to imaging device to retrieve media characteristics and synchronize print settings with an imaging device; and

FIG. 5 is an example method of utilizing a media identifier to order additional supplies.

### DETAILED DESCRIPTION OF THE ILLUSTRATED EMBODIMENTS

In the following detailed description, reference is made to the accompanying drawings where like numerals represent like details. The example embodiments are described in sufficient detail to enable those skilled in the art to practice the invention. It is to be understood that other example embodiments may be utilized and that process, electrical, and mechanical changes, etc., may be made without departing from the scope of the disclosure. The following detailed description, therefore, is not to be taken in a limiting sense and the scope of the invention is defined only by the appended claims and their equivalents. In accordance with the features of the disclosure, systems and methods for automatically configuring an imaging device to print on a media using the print settings suitable for the media are provided that receive a barcode corresponding to the media to be printed retrieve the print settings to be used by the imaging device to print on the media; detect conditions of the environment by the imaging device; and adjust the operating parameters to print on the media according to the characteristics of the media and the detected conditions of the environment.

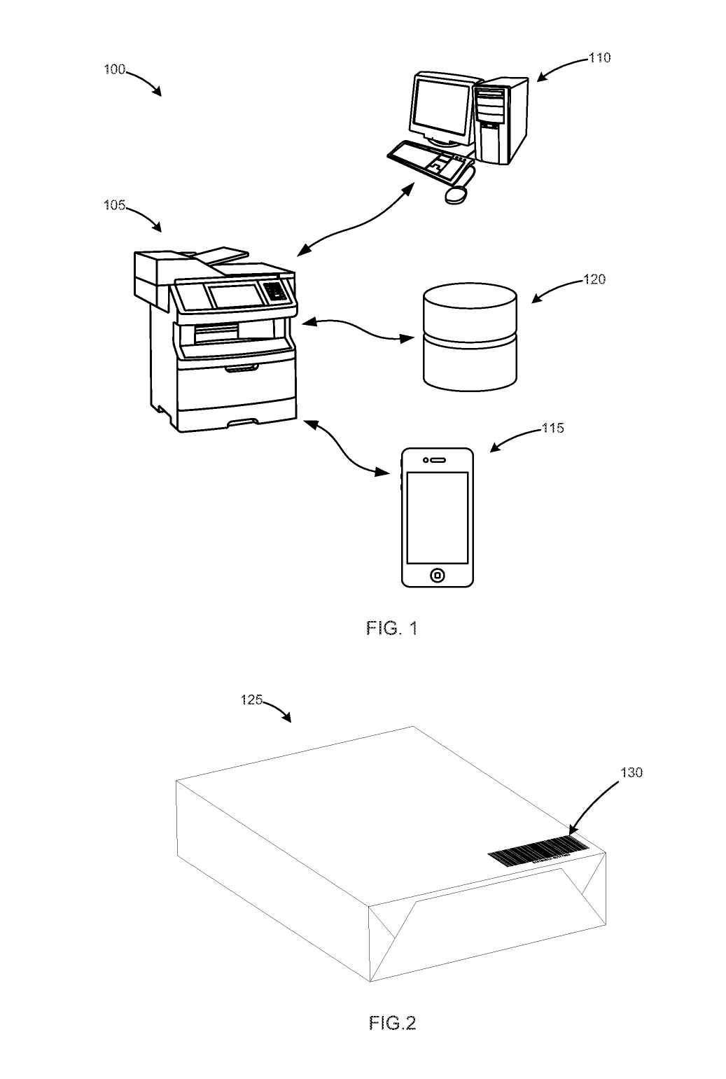

With reference to FIG. 1, there is shown a system 100 including an imaging device 105, a client computer 110, a mobile device 115 and a server 120. FIG. 2 shows an example stack of media 125 with a barcode 130 relating to the media.

Imaging device 105 is any device capable of printing or producing a hard copy corresponding to a data file or document stored in electronic form, such as a laser, inkjet or dot matrix printer or multi-function printing device that has the capability of performing other functions, such as faxing, e-mailing, scanning and/or copying, in addition to printing. Imaging device 105 includes a media input tray for holding a stack of media sheets and a pick mechanism for picking a topmost media sheet from a media feed stack in the media input tray and feeding it towards a media moving section for imaging on the media.

Imaging device 105 includes a means for receiving a barcode relating to a media, and retrieve one or more characteristics of the media to be used in determining print settings for printing on the media. The barcode is read by a barcode scanner communicatively connected to imaging device 105 such that a controller of imaging device 105 receives the barcode scanned by the barcode scanner, and uses the barcode to determine the characteristics of the media and retrieve print settings suitable for printing on the media. Alternatively, imaging device 105 may be a multi-function device (“MFD”) capable of any combination of scanning, faxing, copying, or printing functions. A scanning device communicatively connected to imaging device 105 may scan the barcode and send the information scanned from the barcode to the imaging device 105.

In one alternative example embodiment, imaging device 105 includes a user interface such as, for example, a touch screen application or a touch screen or a key pad that prompts a user of imaging device 105 to enter an input corresponding to a barcode, or any other resource that may be used by imaging device 105 to retrieve information of a media to be used by imaging device 105.

Imaging device 105 includes one or more print settings accessible by a user of imaging device 105 through the user interface, a printer driver associated with imaging device 105, and/or a file being printed. The print settings may include options that may be adjusted by the user prior to printing a file such as, for example, paper type, paper weight, paper texture, print resolution, duplex/simplex options, paper tray selection, color profiles, among others.

Imaging device 105 also includes operating parameters which refer to conditions of imaging device 105 in performing an operation such as, for example, printing on a media. Operating parameters are set based on the printer settings and one or more sensors in imaging device 105. User of the imaging device 105 may include the operating parameters to be used by imaging device 105 based on the printer settings that the user chooses.

Imaging device 105 further includes one or more means for detecting one or more conditions of the environment. The detected environmental conditions are used to adjust the operating parameters that are suitable for printing on the media under the detected environmental conditions. For example, imaging device 105 may include a temperature sensor assembly that monitors temperature of the imaging device 105, or one or more specific parts of imaging device 105 such as, for example, a heated roller included in a fixing section of imaging device 105. Imaging device 105 may also include a humidity sensor that monitors the humidity of imaging device 105, or one or more parts of imaging device 105, and one or more pressure sensors for operating imaging device 105 in a variety of altitudes. The environmental conditions may also be referred herein as sensor data and may further include temperature of the air in imaging device 105, humidity of the imaging device 105, the resistance of the rolls, the current temperature of the fuser, the reflection of the ITM belt, and calibration data about various other sensors, among many others. Other conditions of the environment that may affect printing of imaging device 105 on a media having one or more characteristics will be known by skilled artisans.

Imaging device 105 takes the printer settings and environmental conditions to specify the optimum operating parameters. Operating parameters may include, but are not limited to, fuser heater temperature, fuser backup roll temperature, black first transfer voltage, color transfer voltage, print head motor speed, color tables, second transfer voltage, among others.

Client computer 110 is a computing device having an interface component adapted to connect to imaging device 105 and server 120. For example, client computer 110 may be a laptop computer, a personal computer, workstation computer or any device that includes a processor (not shown) and a computer-readable medium (not shown), such as a random access memory (RAM), coupled to the processor. The processor executes computer-executable program instructions stored in the memory. Computer-executable program instructions stored in the memory includes an application that allows a user to input information corresponding to a media to be used by imaging device 105 in order to determine characteristics of the media and retrieve optimal print settings for printing on the media. Information may be a barcode, or a media identifier associated with one or more characteristics of the media which may be used to retrieve the print settings suitable for the media, as will be explained in greater detail below.

Mobile device 115 is any computing device that is portable, handheld, pocket-sized, or the like. Mobile device 115 may include a display screen, a camera, and/or a barcode reader. In some embodiments, mobile device 115 may include a barcode reader application, or any image-capture functionality that can read a barcode or an image having encoded information. Mobile device 115 may also include a printer driver or file transfer application, such as a printing application, that enables it to communicate with imaging device 105 or send settings to imaging device 105. Examples of mobile devices include, but are not limited to, mobile computers, laptop computers, tablet computers, mobile phones, personal digital assistants, portable media players, mobile internet devices, calculators, handheld game consoles, personal navigation devices, pagers, smart phones and enterprise digital assistants.

Server 120 is a computing device communicatively connected to imaging device 105, client computer 110 and mobile device 115. Server 120 may be a database server that includes one or more databases storing information relating to the various media and corresponding print settings that allow imaging device 105 to print on the media using optimal parameters suited for the media.

In an example embodiment, imaging device 105 utilizes the scanned barcode to access one or more tables in server 120 that contains information regarding characteristics of the media (e.g. media type, media weight, media texture) matched with optimum image device settings that correspond to the media characteristics. Image device settings may include print speeds, developer voltages, fixing temperature, and color tables to be used for developing consistent colors across different media types, toner type, among others.

In an alternative example embodiment, server 120 is accessed by at least one of client computer 110 and mobile device 115 when client computer 110 and/or mobile device 115 are used to set imaging device print settings suitable for the characteristics of the media.

FIG. 2 shows a stack of media 125 with barcode 130 relating to media 125. Media 125 is any imaging device media such as, for example, paper that is fed into imaging device 105 for printing. Media 125 may include one or more media characteristics that refer to a specification of the media. Characteristics may include brand name, product code, finish, weight, paper density (e.g. gsm or grams per square meter), caliper, smoothness, brightness, opacity, stock, and size. Some of these media characteristics are known to affect printing. These characteristics are communicated to the imaging device by print settings in order to achieve the most desirable print quality.

Barcode 130 refers to an indicia disposed on the packaging of media 125 that corresponds to an identifier associated with the media and its characteristics. Barcode 130 may be a one-dimensional or linear barcode or a high-density two-dimensional barcode such as, but not limited to, a PDF417, DataMatrix and QRCode barcode. Barcode 130 may be information that is available on most, if not all, types of media such as a stock keeping unit identifier of the media that is used to uniquely identify the manufacturer, product description, material, size, color, packaging, and other specification of the media.

When captured and decoded by an application such as, for example, a barcode reader in imaging device 105 or a barcode reader application in mobile device 115, barcode 130 is used to obtain a media identifier that is used to look up characteristics of the media on the server 120 or on imaging device 105, and retrieve print settings to be used by imaging device 105, as will be discussed in greater detail below.

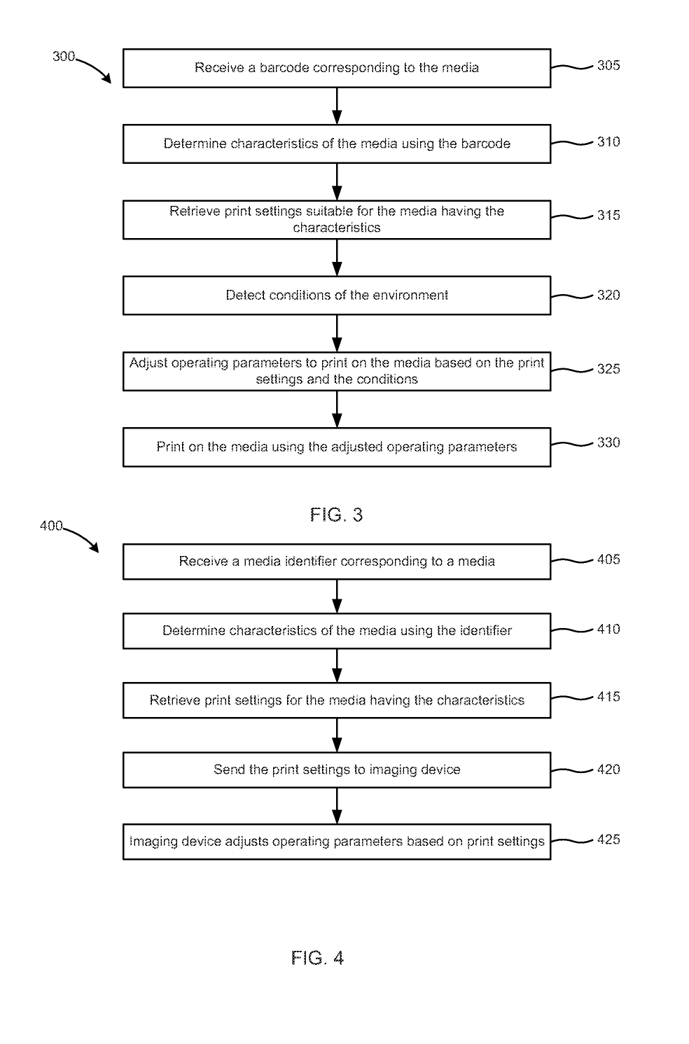

FIG. 3 is a flowchart showing an example method 300 of configuring an imaging device to print on a media using the print settings suitable for the media. Method 300 may be performed by one or more computer instructions stored in imaging device 105 in example system 100 shown in FIG. 1.

At 305, barcode 130 corresponding to an identifier of media 125 is received by imaging device 105. Receiving barcode 130 may include sensing the barcode from a scanning device communicatively connected to the imaging device 105. Alternatively, the barcode may be received by imaging device 105 from an indicia reader or a barcode scanner application that reads the barcode. It will be understood that the barcode scanner application may be a software application that is stored in memory associated with the control unit and executed by the control unit in accordance with programmed logic associated with the software application. In some alternative embodiments, the barcode scanner application may be implemented in the firmware of imaging device 105. In yet other alternative embodiments, the barcode scanner application may be implemented as a combination of firmware and software.

In one example embodiment, imaging device 105 receives the barcode in response to a prompt by imaging device 105 for a user to enter a barcode corresponding to an identifier of a media upon a media tray of imaging device 105 receiving the media. The prompt may be displayed on the user interface of imaging device 105 that requests for a media identifier input corresponding to the media received by the media tray and will be used by imaging device 105 for printing. In an alternative example embodiment, the prompt may be an audio signal.

In an alternative example embodiment, imaging device 105 receives the media identifier in a format other than the barcode. For example, imaging device 105 may receive the media identifier as a series of characters corresponding to the identifier that may be entered by a user using a keypad of imaging device 105. In another alternative example embodiment, imaging device 105 may receive an indicia relating to the media such as, for example, an RFID tag or a QR code encoded with the media identifier. Other types of indicia that may be received by imaging device 105 may include but are not limited to characters, including numbers or integers, manually inputted by a user, or read by a scanning device or application communicatively connected with imaging device 105, and a color code that may be read by the scanning device and application. The indicia may be received by imaging device 105 through the use of an appropriate indicia reader, as will be known in the art.

At 310, one or more characteristics of the media are determined using the information found in the barcode received by imaging device 105. Example of media characteristics may include brand of the media, product code, media size, media weight, media type, and media texture. It will be understood that upon imaging device 105 receiving the barcode at block 305, imaging device 105 performs one or more computer instructions that translates the barcode to determine the media identifier. The media identifier is then used to determine the one or more characteristics of the media. In an alternative example embodiment, the information in the barcode is translated and combined with an identifier of the media tray of imaging device 105 in order to determine the print settings to be used by imaging device 105 for printing on the media associated with the barcode.

Determining the operating parameters to be used by imaging device 105 for printing on the media may include accessing a media translate table included in a database from a remote server such as server 120 to retrieve information regarding various types of media. Retrieving the information regarding the media associated with the barcode may include interrogating server 120 for printer settings of the media such as, for example, the media type, media weight, and media texture of the media. Interrogating server 120 further includes querying the server using the media identifier from the barcode and information relating to imaging device 105 such as the identifier of the media tray or model of the imaging device 105 to retrieve the print settings. Other examples of storage databases from which information may be retrieved includes a client computer, a server, a mobile device, or any device capable of storing digital information.

In an alternative example embodiment, a memory of imaging device 105 may include one or more tables associating various media identifiers with one or more characteristics of the corresponding media. In this example embodiment, imaging device 105 may retrieve the information from its memory without connecting to server 120. The one or more tables in the memory of imaging device 105 may be regularly updated by connecting to server 120 on a pre-defined schedule to add, delete or modify one or more entries of the tables.

At 315, one or more print settings to be used by imaging device 105 for printing on the media having a specific set of characteristics are retrieved by imaging device 105. The print settings are retrieved using the media identifier decoded from barcode 130. The one or more print settings may be the most desirable settings to be used by imaging device 105 to print on the media having the characteristics.

Retrieving the print settings may be performed by accessing a database from server 120 to retrieve print settings associated with the one or more characteristics of the media. The database may contain a media translate model which may be used to determine the optimal imaging device operating parameters such as, voltages, fixing temperatures, media speeds, to be used to print on the media. Alternatively, the associated print settings may be retrieved from the memory of imaging device 105.

At 320, environmental conditions are detected by imaging device 105. Detecting conditions of the environment is performed by using one or more sensors in imaging device 105 for detecting environmental conditions that may affect performance of imaging device 105 when printing on the media. Environmental conditions that are detected include, but are not limited to, temperature, humidity and pressure.

Fluctuations in environmental conditions such as, for example, temperature, humidity and pressure changes, can act on components of imaging device 105 that may cause the components to vary, thereby affecting the performance of imaging device 105 when printing on the media. As such, the one or more print settings retrieved at 315 based on the characteristics of the media can be used to adjust the operating parameters of imaging device 105 to perform at a desirable level based on the print settings and the detected environmental conditions (at 325). The operating parameters adjusted by imaging device 105 may include, but is not limited to, print voltage, print speed, laser power, fusing temperature having values that will produce the highest quality output for that media.

For example, if the print settings received by imaging device 105 indicate settings to use in printing a normal 90 gsm office media, imaging device 105 sets the paper type to “normal”, paper weight to “normal” and paper texture to “normal”. This sets the operating parameters of imaging device 105 to print on the media at full speed but the speed may still be affected by the current environmental conditions. After the print settings has been set, environmental conditions such as, for example, temperature of the air in imaging device 105 are then determined. For illustrative purposes, the temperature may be reported as a low temperature. Imaging device 105 then adjusts the operating parameters of the machine such as raising the nominal temperature of the fuser to compensate for the cold air within the device, allowing imaging device 105 to print at full speed. Initially, the operating parameter (e.g. fuser temperature) was influenced by the paper type but it is further adjusted based on the detected environmental condition.

In another example, imaging device 105 may have been used to print for two hours thereby building up a considerable amount of heat inside the machine The same 90 gsm office media is being printed on, and operating parameters have been adjusted to print using the print settings for that media. Imaging device 105 may detect an updated environmental condition to determine that the device has a higher residual heat from printing at full speed for a long period of time. Consequently, imaging device 105 may then adjust its operating parameters to print at half speed to lower down the residual heat and maintain desirable environmental conditions within the device.

In one example embodiment, imaging device 105 can also select and/or adjust one or more color tables to be used to print on the media based on the characteristics of the media and the detected environmental conditions. Selecting color tables for use in printing allows for consistent colors across paper types in various environmental conditions.

At 330, imaging device 105 is then configured to print on the media having the one or more characteristics using the adjusted imaging device operating parameters.

In one example embodiment, the use of the adjusted one or more operating parameters that were determined based on both the characteristics of the media and the detected environmental conditions are retained for use by the imaging device 105 until the media tray of imaging device 105 receives a new media. For example, if imaging device 105 has adjusted its operating parameters for use in printing on a photographic paper, imaging device 105 may continue using the operating parameters associated with printing on a photographic paper until after the media tray receives a new media having a different type such as, for example, a recycled media having a light media weight. When the new media is received, a prompt to enter a new barcode or media identifier is executed for receiving a new barcode and adjust print settings for the new media, as discussed in accordance with the example method of FIG. 3.

In another example embodiment, the use of the adjusted one or more operating parameters determined based on a particular set of media characteristics and environmental conditions are retained for use until the one or more sensors of imaging device 105 detects environmental conditions that are significantly different from the previously detected environmental conditions. Sensors of imaging device 105 may consistently monitor the conditions to check if the operating parameters currently used by imaging device 105 to print on the media are still the best operating parameters that could provide the highest quality of output. If not, imaging device 105 may further adjust the operating parameters based on the newly detected conditions, thereby providing a more consistent quality of printing.

In another example embodiment, the media and its characteristics may be stored in the memory of imaging device 105 such that the user may select the stored media information to set print settings in imaging device 105 for printing on the media. For example, imaging device 105 may store one or more “Media Profiles” that may be used to automatically set the print settings without performing the receiving of barcode and the retrieving of media characteristics and corresponding print settings.

FIG. 4 is an example method 400 of using a device connected to imaging device 105 to retrieve media characteristics and synchronize information with imaging device 105. Method 400 may be performed by one or more computer instructions stored in a non-transitory readable medium in the device. For illustrative purposes, method 400 will be discussed as being performed by mobile device 115 connected to imaging device 105 but it will be understood by skilled artisans of the art that method 400 may also be performed by client computer 110 having a direct connection through a network with imaging device 105.

At 405, mobile device 115 receives a media identifier corresponding to a media. Media identifier may be barcode 130 in a packaging of media to be used by imaging device 105. Alternatively, the media identifier may be one or more characters that is used to identify the media and is associated with one or more characteristics of the media.

Receiving the media identifier may be performed by using a barcode reader or any other kind of indicia reader communicatively connected with mobile device 115 to read the barcode. In an alternative example embodiment, mobile device 115 may receive the media identifier using one or more input interfaces connected to mobile device 115 that allows a user to enter the media identifier. Receiving the media identifier may also utilize an application in client device 110 that is capable of establishing connection with imaging device 105 and/or server 120 such as, for example, an imaging device driver.

At 410, mobile device 115 determines characteristics of the media using the media identifier. Determining the characteristics may include interrogating server 120, using at least one of mobile device 115, imaging device 105 or client computer 110 to determine the media characteristics associated with the media identifier. Determining the characteristics of the media may include accessing a media translate table on at least one of the server, mobile device 115 or on imaging device 105.

Once the characteristics of the media are determined, print settings suited for use by imaging device 105 for printing on the media having the characteristics may be retrieved (at 415). The print settings are retrieved from a database in server 120 or in a memory of mobile device 115. In an alternative example embodiment, an identifier of the media tray of imaging device 105 may also be used to determine the optimal print settings to be used by imaging device 105. An imaging device model may also be used to determine the optimal operating parameters to be used by the imaging device to print on the media.

At 420, the retrieved print settings are then sent by mobile device 115 to imaging device 105 for use by imaging device 105 to print on the media. Using mobile device 115 to retrieve media characteristics and print settings best suited for printing on the media having the characteristics allows a user to remotely configure and synchronize information with imaging device 105. Synchronizing the information between mobile device 115 and imaging device 105 can be performed using one or more communication means such as, for example, a wireless data connection, Bluetooth, and other communication means as will be known by skilled artisans.

Upon imaging device 105 receiving the print settings from mobile device 115, imaging device 105 updates its operating parameters in accordance with the received print settings automatically upon receiving the settings, or on a predefined schedule (at block 425). In an alternative example embodiment, imaging device 105 may further adjust the operating parameters to take into consideration environmental conditions detected by imaging device 105, in accordance with the detection and adjustment steps in method 400 of FIG. 4. As aforementioned, adjusting the operating parameters in accordance with both the characteristics of the media and the detected conditions of the environment ensures that the quality of printing on the media is desirable and consistent.

In one aspect of the present disclosure, configuring imaging device 105 to print based on the print settings retrieved by one of imaging device 105, client computer 110 and mobile device 115 is performed manually by a user of imaging device 105. In this example embodiment, a user retrieves the characteristics of the media by manually entering a media identifier in an application using one of imaging device 105, client computer 110 and mobile device 115. The application considers the media identifier input as a query and return to the user the characteristics of the media, which are then used by the user as a guide for configuring imaging device 105. For example, the user may manually enter a barcode and an imaging device model on an application in mobile device 115 and instead of mobile device 115 automatically retrieving the print settings and sending the print settings to imaging device 105 for automatic configuration, mobile device 115 returns the characteristics of the media that will be used by the user to set up the print settings of imaging device 105. The user may also manually enter the barcode and the imaging device model on a website such as, for example, a customer support website for the specific imaging device brand and model, and receive the printer settings corresponding to operating parameters to be used to print by the imaging device having the imaging device model. Providing the user with the printer settings allows the user to provide more accurate details to imaging device 105.

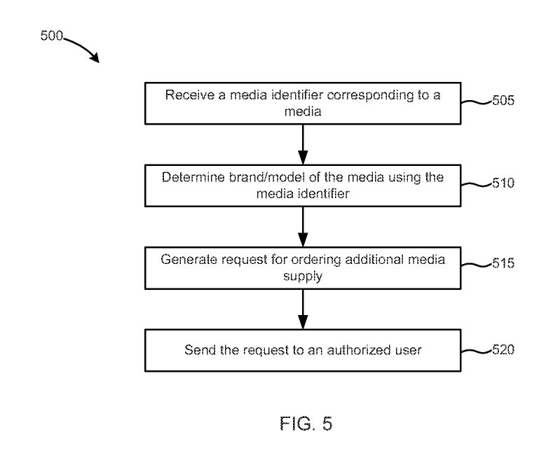

In another aspect of the present disclosure, the media identifier retrieved from barcode 130 is used to order additional supplies for imaging device. FIG. 5 is an example method 500 of utilizing a media identifier to conveniently order additional supplies. Method 500 can be performed by imaging device 105. In alternative example embodiments, method 500 may also be performed by client device 110 and/or mobile device 115.

At 505, a media identifier corresponding to a media is received by imaging device 105. Receiving the media identifier may include receiving a barcode from a barcode reader, a scanning device, an image-capturing device or a barcode scanner application in at least one of imaging device 105, client device 110 and mobile device 115. The media identifier may be in another format that will be received by the devices using one or more input interfaces as will be known in the art.

At 510, a brand and model, or any unique identifier corresponding to the stock keeping unit (SKU) of the media is retrieved using the media identifier. The unique identifier may be retrieved from a database in server 120, or from a memory of imaging device 105.

At 515, a request for ordering additional media supply corresponding to the media may be generated. Generating the request may include composing an e-mail or a notification that may be sent to an authorized user (e.g. administrator of system 100) that details the request of additional media supply (at 520). In an alternative embodiment, the request may be directly sent from imaging device 105 to a supplier of the media.

The foregoing illustrates various aspects of the invention. It is not intended to be exhaustive. Rather, it is chosen to provide the best illustration of the principles of the invention and its practical application to enable one of ordinary skill in the art to utilize the invention, including its various modifications that naturally follow. All modifications and variations are contemplated within the scope of the invention as determined by the appended claims. Relatively apparent modifications include combining one or more features of various embodiments with features of other embodiments.

1. A method of automatically configuring an imaging device to print on a media using one or more operating parameters of the imaging device, comprising:
receiving a barcode corresponding to the media to be printed on by the imaging device;
determining one or more characteristics of the media using the barcode;
determining the one or more operating parameters to be used by the imaging device to print on the media having the one or more characteristics;
detecting, by the imaging device, one or more conditions of an environment; and
adjusting the one or more operating parameters to print on media according to the determined one or more characteristics of the media and the detected environmental conditions.

2. The method of claim 1, wherein the receiving the barcode includes reading the barcode using a scanning device connected to the imaging device.

3. The method of claim 1, further comprising prompting a user of the imaging device to enter an input corresponding to the barcode upon a media tray of the imaging device receiving the media.

4. The method of claim 1, wherein the determining the one or more operating parameters includes retrieving one or more print settings from a database on a server remotely connected to the imaging device corresponding to the media.

5. The method of claim 1, wherein the determining the one or more characteristics of the media includes querying a database on a server remotely connected to the imaging device for the one or more characteristics associated with the barcode.

6. A method of automatically configuring an imaging device to print on a media using an imaging profile suitable for the media, comprising:
associating an indicia of a media with a predetermined imaging profile suitable for printing on the media;
detecting, by the imaging device, one or more environmental conditions; and
adjusting the predetermined imaging profile to print on the media based on the detected environmental conditions.

7. The method of claim 6, further comprising obtaining the indicia from an indicia reader communicatively connected with the imaging device.

8. The method of claim 6, further comprising retrieving the predetermined imaging profile associated with the indicia from a remote computer communicatively connected with the imaging device.

9. The method of claim 6, further comprising printing on the media using the adjusted predetermined imaging profile.

10. The method of claim 6, wherein the detecting includes detecting at least one of a temperature, humidity and pressure conditions of the environment.

11. The method of claim 6, wherein the associating the indicia of the media with the predetermined imaging profile includes associating the indicia of the media with a color table to be used to print on the media.

12. The method of claim 6, wherein the associating the indicia of the media with the predetermined imaging profile includes associating the indicia with at least one of a printing speed, laser power, fusing temperature and voltage for use in printing on the media.
